(19) United States
(12) Patent Application Publication
(10) Pub. No.: US 2012/0196550 A1
(43) Pub. Date: Aug. 2, 2012

(54) APPARATUS FOR VEHICLE AND SIGNAL PROCESSING METHOD

(75) Inventor: Wei-Cheng Wang, Santa Ana, CA (US)

(73) Assignee: I O INTERCONNECT, LTD., Santa Ana, CA (US)

(21) Appl. No.: 13/193,878

(22) Filed: Jul. 29, 2011

Related U.S. Application Data
(60) Provisional application No. 61/438,623, filed on Feb. 1, 2011.

(51) Int. Cl. H04B 1/38

(52) U.S. Cl. 455/90.2

(57) ABSTRACT

An apparatus for a vehicle. A charging module provides a charging function in a wired or wireless manner to charge up a portable electronic device. A transceiver module receives signals from the portable electronic device and transmits enhanced signals through an air interface. A signal repeating unit receives the signals and enhances the signals to generate the enhanced signals.

### CROSS REFERENCE TO RELATED APPLICATIONS

This application claims the benefit of U.S. Provisional Application No. 61/438,623 filed Feb. 1, 2011 and entitled “In-car electronic device having signal and/or data transmission functions”. The entire contents of which are hereby incorporated by reference.

### BACKGROUND OF THE INVENTION

1. Field of the Invention

The invention relates to an apparatus for a vehicle, and more particularly to an apparatus for a vehicle provided with at least a charging function and a signal repeating function.

2. Description of the Related Art

Portable electronic devices, such as portable personal communication devices and portable tablet personal computers, are very popular currently, since they provide users with convenient voice communications and network access functions anywhere without location restrictions. However, when users use the portable electronic devices in a moving vehicle, unstable signal quality and high power consumption problems may cause undesired experience thereto.

Therefore, an in-car electronic device to expand the functionality and increase the attraction of a portable electronic device is eagerly sought out for development.

### BRIEF SUMMARY OF THE INVENTION

An apparatus for a vehicle and signal processing method for processing signals are provided. An exemplary embodiment of an apparatus for a vehicle comprises a charging module, a transceiver module and a signal repeating unit. The charging module provides a charging function in a wired or wireless manner to charge up a portable electronic device. The transceiver module receives a plurality of signals from the portable electronic device and transmits a plurality of enhanced signals through an air interface. The signal repeating unit receives the signals and enhances the signals to generate the enhanced signals.

Another exemplary embodiment of a signal processing method for processing a plurality of signals comprises: providing a vehicle-use apparatus with at least a charging function and a signal repeating function; electrically connecting a portable electronic device to the vehicle-use apparatus; extracting the signals from the portable electronic device and transmitting the signals to the vehicle-use apparatus; enhancing the signals to generate a plurality of enhanced signals by the vehicle-use apparatus; and transmitting the enhanced signals through an air interface by the vehicle-use apparatus.

An exemplary embodiment of a vehicle-use apparatus for a vehicle comprises a connection interface, a charging module, a transceiver module and a signal repeating unit. The connection interface is coupled to a portable electronic device in a wired or wireless manner. The charging module receives electric power from the vehicle and provides the electric power through the connection interface to charge up the portable electronic device. The transceiver module receives a plurality of signals from the portable electronic device through the connection interface and transmits a plurality of enhanced signals through an air interface. The signal repeating unit receives the signals and enhances the signals to generate the enhanced signals.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic block diagram of an apparatus according to an embodiment of the invention;

FIG. 2 shows an exemplary vehicle-use device with an apparatus integrated therein according to an embodiment of the invention;

FIG. 3 shows another exemplary vehicle-use device with an apparatus mounted therein according to another embodiment of the invention;

FIG. 4 shows a schematic diagram of another communication system according to another embodiment of the invention; and

FIG. 5 shows a flow chart of a signal processing method for processing a plurality of signals according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

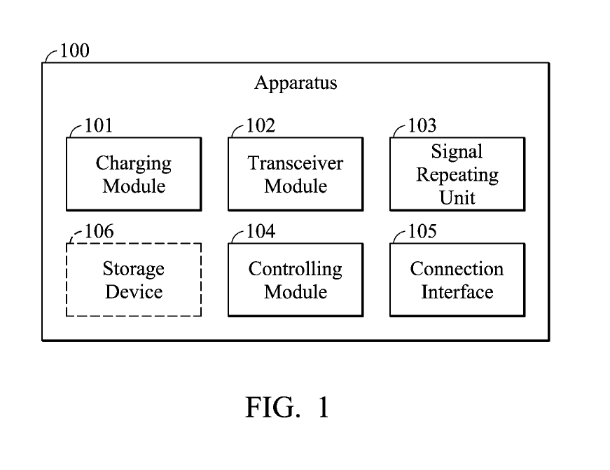

FIG. 1 shows a schematic block diagram of an apparatus according to an embodiment of the invention. The apparatus 100 may at least comprise a charging module 101, a transceiver module 102 and a signal repeating unit 103. The charging module 101 is arranged to provide a charging function to charge up a portable electronic device (which will be discussed in the following paragraphs). The transceiver module 102 is arranged to receive a plurality of signals from the portable electronic device and transmit a plurality of enhanced signals through an air interface. The signal repeating unit 103 is arranged to receive the signals and enhance the signals to generate the enhanced signals. In one embodiment of the invention, the signal repeating unit 103 may comprise a power amplifier to enhance a level or power of the signals. Note that the signal repeating unit 103 may directly receive the signals from the portable electronic device, or receive the signals from the portable electronic device via the transceiver module 102, and the invention should not be limited thereto. In addition, in some embodiments of the invention, the signal repeating unit 103 may also be comprised by the transceiver module 102, and the invention should not be limited thereto.

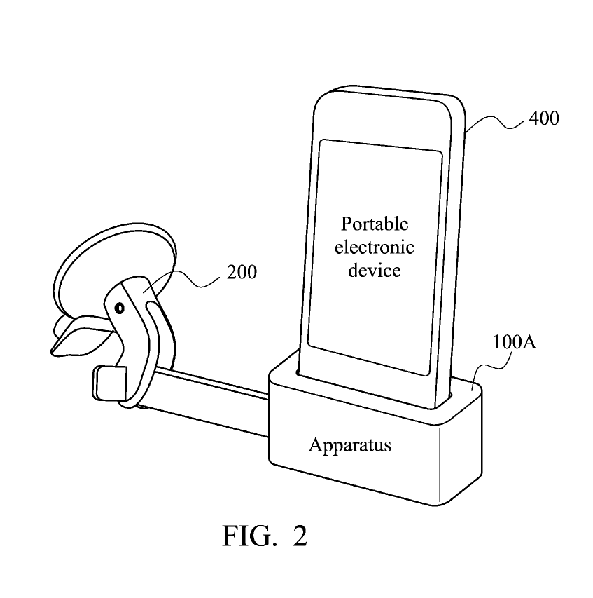

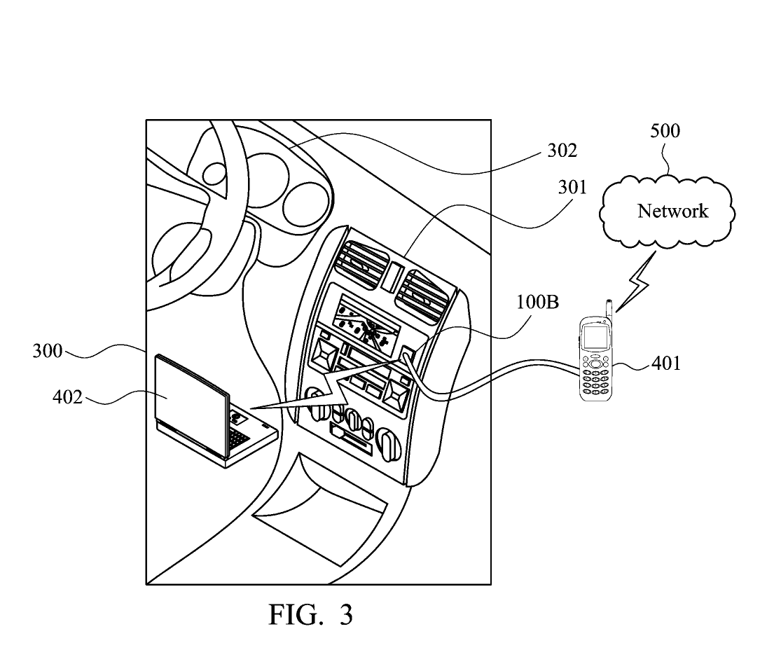

According to an embodiment of the invention, the apparatus 100 may be an electronic device configured inside of a vehicle (for example, a car, an automotive vehicle, or the likes), capable of providing a charging function for the portable electronic devices inside of or nearby the vehicle. To be more specific, the apparatus 100 may be integrated with or mounted in a vehicle-use device, for example, and not limited to, a car-cradle, a dashboard or a control section of the vehicle. FIG. 2 shows an exemplary vehicle-use device with an apparatus integrated therein according to an embodiment of the invention. In the embodiment, the apparatus 100A integrated with a car-cradle 200 is presented in a form as a charging dock capable of charging up a portable electronic device 400. FIG. 3 shows another exemplary vehicle-use device with an apparatus mounted therein according to another embodiment of the invention. In the embodiment, the apparatus 100B is mounted in a control section 301 of the vehicle 300 and may be regarded as a part of the vehicle 300, and is capable of charging up the portable electronic devices 401 and 402 electrically connected thereto. Note that the apparatus 100, 100A and/or 100B may also be integrated with or mounted in any other vehicle-use device of a vehicle. FIG. 2 and FIG. 3 only show some exemplary designs based on the invention concept, and the invention should not be limited thereto. For example, the apparatus 100B may also be mounted in the dashboard 302 of the vehicle 300. Note also that the drawings illustrate the portable electronic devices as a cell phone and a notebook. However, the present innovation should not be limited thereto.

According to the embodiment of the invention, one or more electronic devices may be electrically connected to the apparatus 100, 100A and/or 100B for battery charging. The charging module 101 may receive electric power from a power source of the vehicle and use the electric power to charge up the portable electronic devices. Note that the electric connection may be presented in either a wired or wireless manner, and the invention should not be limited to either case. For example, in one embodiment of the invention, the apparatus 100, 100A and/or 100B may be connected to the portable electronic device via a connection interface 105 as shown in FIG. 1, so as to provide the electric power through the connection interface 105 to the portable electronic device to charge up the portable electronic device. Note that the connection interface may be implemented as a tangible connector to directly connect to the portable electronic devices. However, the connection interface may also be implemented as a communication interface facilitating establishment of a wireless connection between the apparatus and the portable electronic devices. Therefore, the charging module 101 may directly charge up the portable electronic device, or wirelessly charge up the portable electronic device through the air interface and the invention should not be limited to either cases.

When a portable electronic device (or multiple portable electronic devices, and the present innovation is not limited thereto) is electrically connected to the apparatus 100, 100A and/or 100B, the apparatus 100, 100A and/or 100B may act as a repeater to receive signals from the portable electronic device, enhance the signals and transmit the enhanced signals out through the air interface. According to an embodiment of the invention, the signals may be transmitted from the portable electronic device to the apparatus 100, 100A and/or 100B via the electric connection therebetween. The electric connection may be presented in either a wired or wireless manner, and the invention should not be limited thereto. For example, as shown in FIG. 2, the signals may be transmitted from the portable electronic device 400 to the apparatus 100A via the pins of a connector (not shown) connected therebetween. For another example, as shown in FIG. 3, the signals may be transmitted from the portable electronic device 401 to the apparatus 100B via the wire connected therebetween. For yet another example, the signals may also be wirelessly transmitted from the portable electronic device 402 to the apparatus 100B via the air interface in compliance with a predetermined wireless transmission protocol.

According to an embodiment of the invention, the portable electronic device 400, 401 and/or 402 may be equipped with one or more predetermined communication module(s) to provide predetermined wireless communications service(s) in compliance with predetermined wireless transmission protocol(s). When the apparatus 100, 100A and/or 100B is electrically connected to (either in a wired or a wireless manner) the portable electronic device, a new function of providing network access services, such as a hotspot or access point, may be achieved. Take FIG. 3 as an example, when the apparatus 100B is electrically connected to (either in a wired or a wireless manner) the portable electronic device 401, a communication system may be formed by the apparatus 100B and the portable electronic device 401 and the peer portable electronic device 402 may establish a wireless connection with the portable electronic device 401 via the apparatus 100B. For example, the transceiver module 102 may transmit the enhanced signals, which are received from the portable electronic device 401 and enhanced by the signal repeating unit 103 of the apparatus 100B, to the peer portable electronic device 402 through the air interface so as to facilitate a wireless connection established between the portable electronic device 401 and the peer portable electronic device 402. Having the wireless connection established therebetween, the apparatus 100B and the portable electronic device 401 may further act as a hotspot (or so-called access point) to facilitate the peer portable electronic device 402 to connect to an internet (such as the network 500 shown in FIG. 3) therethrough.

For example, when the portable electronic device 401 is equipped with a WiFi communication module, the WiFi signals generated by the portable electronic device 401 for providing communication services and/or Network access functions may be passed to the apparatus 100B, repeated and then transmitted by the apparatus 100B through the air interface. Any WiFi compatible peer electronic device, such as the portable electronic device 402, may receive the WiFi signals transmitted by the apparatus 100B from the air interface, and use the communication services and/or connect to the Network via the portable electronic device 401 and the apparatus 100B.

For another example, when the portable electronic device 401 is equipped with a UMTS communication module, the 3G signals generated by the portable electronic device 401 for providing communication services and/or Network access functions may be passed to the apparatus 100B, repeated and then transmitted by the apparatus 100B through the air interface. Any 3G compatible peer electronic device, such as the portable electronic device 402, may receive the 3G signals from the air interface, and use the communication services and/or connect to the Network via the portable electronic device 401 and the apparatus 100B.

Note that in the embodiments of the invention, even if the portable electronic device is not charged by the apparatus, as long as the portable electronic device is electrically connected to the apparatus, the signals may be transmitted therebetween. In other words, the apparatus and the portable electronic device may act as a hotspot or an access point regardless of whether the portable electronic device is being charged by the apparatus.

According to another embodiment of the invention, the apparatus 100, 100A and/or 100B may further comprise a controlling module 104 as shown in FIG. 1 for controlling the signal received from and/or transmitted to the portable electronic device. The controlling module 104 may be a controller chip controlling the transceiver module 102 or signal repeating unit 103 to extract the signals from the portable electronic device, and/or direct the signals received from the air interface to the portable electronic device. Note also that according to yet another embodiment of the invention, the controlling module 104 may also be implemented in the side of the portable electronic device and the invention should not be limited thereto. For example, the controlling module may be a software application function installed in the portable electronic device for controlling the signals to be transmitted to and/or received from the apparatus.

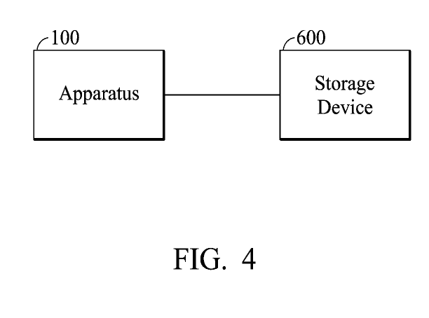

FIG. 4 shows a schematic diagram of another communication system according to another embodiment of the invention. In one aspect of the invention, the apparatus 100 may further be electrically connected to a storage device 600, and integrated with the storage device 600 as a NAS (network attached storage) system. Network attached storage (NAS) is a file-level data storage device connected to a Network for providing data access to heterogeneous clients. According to an embodiment of the invention, the apparatus 100 may be equipped with a connector, such as a USB port, to electrically connect to the storage device 600. The storage device 600 may be a USB dongle, a hard disk, a card reader with memory card(s) inserted therein, or others. Because, as previously described, the apparatus may act as a repeater or hotspot, along with the portable electronic device electrically connected thereto to provide communication services and/or Network access functions, the apparatus may further be a NAS when a storage device 600 is electrically connected thereto.

Take the apparatus 100B shown in FIG. 3 as an example, a peer electronic device, such as the portable electronic device 402, that is connecting to the Network 500 and using the communication service via the portable electronic device 401, may further access the data stored in the storage device of the portable electronic device 401 or stored in any storage device electrically connected to the apparatus 100B. To be more specific, the portable electronic device 402 may issue a data access request for wireless access of data through the apparatus 100B. The transceiver module 102 may transmit the data stored in the storage device through the air interface in response to the data access request received from the portable electronic device 401, which has a wireless connection with the portable electronic device 402 as previously described. Note that in some embodiments, the data access request may be transmitted from the portable electronic device 402 to the portable electronic device 401 or from the portable electronic device 402 to the apparatus 100B, and the invention should not be limited thereto. Note also that in some embodiments, the storage device may also be a built-in storage device inside of the apparatus, such as the storage device 106 show in FIG. 1, and the invention should not be limited thereto.

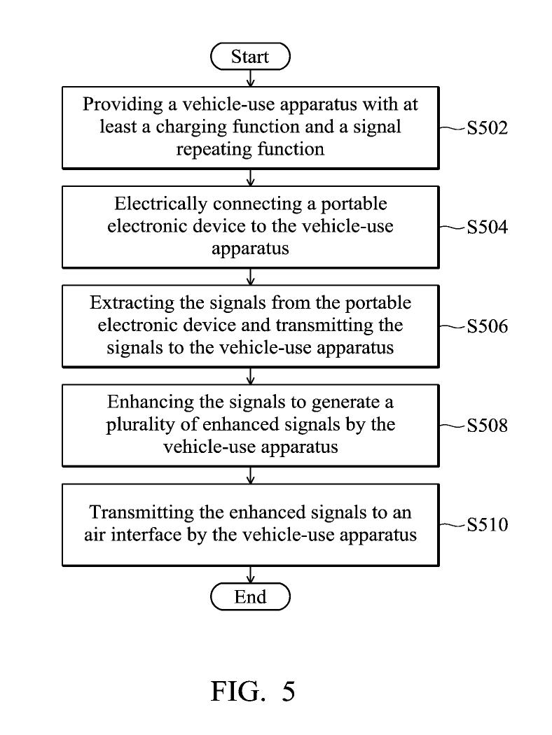

FIG. 5 shows a flow chart of a signal processing method for processing a plurality of signals according to an embodiment of the invention. A vehicle-use apparatus with at least a charging function and a signal repeating function is first provided (Step S502). The vehicle-use apparatus may be the vehicle-use device as shown in FIG. 2, FIG. 3, or the likes, with an apparatus as shown in FIG. 1 integrated or mounted therein. Next, a portable electronic device is electrically connected to the vehicle-use apparatus (Step S504). Next, the signals are extracted from the portable electronic device and transmitted to the vehicle-use apparatus (Step S506). Next, the signals are enhanced by the vehicle-use apparatus to generate a plurality of enhanced signals (Step S508). Finally, the enhanced signals are transmitted by the vehicle-use apparatus through an air interface, so as to facilitate a wireless connection established between the portable electronic device and a peer electronic device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An apparatus for a vehicle, comprising:
a charging module, providing a charging function in a wired or wireless manner to charge up a portable electronic device;
a transceiver module, receiving a plurality of signals from the portable electronic device and transmitting a plurality of enhanced signals through an air interface; and
a signal repeating unit, receiving the signals and enhancing the signals to generate the enhanced signals.

2. The apparatus as claimed in claim 1, further comprising:
a connection interface, connecting the charging module to the portable electronic device,
wherein through the connection interface, the charging module provides the charging function to the portable electronic device to charge up the portable electronic device and the transceiver module receives the signals from the portable electronic device.

3. The apparatus as claimed in claim 1, wherein the charging module receives electric power from the vehicle and uses the electric power to charge up the portable electronic device.

4. The apparatus as claimed in claim 1, further comprising:
a controlling module, controlling the transceiver module to extract the signals from the portable electronic device.

5. The apparatus as claimed in claim 1, wherein the transceiver module further transmits the enhanced signals to a peer electronic device through the air interface so as to facilitate a wireless connection established between the portable electronic device and the peer electronic device.

6. The apparatus as claimed in claim 1, further comprising:
a storage device, for storing data,
wherein the transceiver module transmits the data stored in the storage device through the air interface in response to a data access request received from the portable electronic device.

7. The apparatus as claimed in claim 6, wherein the data access request is issued by a peer electronic device having a wireless connection with the portable electronic device.

8. A signal processing method for processing a plurality of signals, comprising:
providing a vehicle-use apparatus with at least a charging function and a signal repeating function;
electrically connecting a portable electronic device to the vehicle-use apparatus;
extracting the signals from the portable electronic device and transmitting the signals to the vehicle-use apparatus;
enhancing the signals to generate a plurality of enhanced signals by the vehicle-use apparatus; and
transmitting the enhanced signals through an air interface by the vehicle-use apparatus.

9. The method as claimed in claim 8, further comprising:
receiving electric power from the vehicle by the vehicle-use apparatus; and
providing the electric power to the portable electronic device to charge up the portable electronic device by the vehicle-use apparatus.

10. The method as claimed in claim 8, further comprising:
amplifying the signals to generate the enhanced signals by the vehicle-use apparatus.

11. The method as claimed in claim 8, further comprising:
establishing a wireless connection between the portable electronic device and a peer electronic device by using the enhanced signals.

12. The method as claimed in claim 11, further comprising:
facilitating the peer electronic device to connect to an internet through the portable electronic device by the vehicle-use apparatus.

13. The method as claimed in claim 11, further comprising:
providing a storage device electrically connected to the vehicle-use apparatus for storing data; and
issuing a data access request for wirelessly accessing the data through the vehicle-use apparatus.

14. The method as claimed in claim 13, further comprising:
receiving the data access request from the portable electronic device by the vehicle-use apparatus;
accessing the data by the vehicle-use apparatus; and
transmitting the accessed data through the air interface in response to the data access request by the vehicle-use apparatus.

15. The method as claimed in claim 14, wherein the data access request is issued by the peer electronic device and transmitted from the peer electronic device to the portable electronic device.

16. An apparatus for a vehicle, providing a charging function, comprising:
a connection interface, coupled to a portable electronic device in a wired or wireless manner,
a charging module, receiving electric power from the vehicle and providing the electric power through the connection interface to charge up the portable electronic device;
a transceiver module, receiving a plurality of signals from the portable electronic device through the connection interface and transmitting a plurality of enhanced signals through an air interface; and
a signal repeating unit, receiving the signals and enhancing the signals to generate the enhanced signals.

17. The apparatus as claimed in claim 16, further comprising:
a controlling module, controlling the transceiver module to extract the signals from the portable electronic device.

18. The apparatus as claimed in claim 16, wherein the transceiver module further transmits the enhanced signals to a peer electronic device through the air interface so as to facilitate a wireless connection established between the portable electronic device and the peer electronic device.

19. The apparatus as claimed in claim 16, further comprising:
a storage device, for storing data,
wherein the transceiver module transmits the data stored in the storage device through the air interface in response to a data access request received from the portable electronic device.

20. The apparatus as claimed in claim 19, wherein the data access request is issued by a peer electronic device having a wireless connection with the portable electronic device.
